(19) United States
(12) Patent Application Publication
(10) Pub. No.: US 2017/0129796 A1
(43) Pub. Date: May 11, 2017

(54) Hybrid Systems and Methods with Forward Osmosis and Electrodeionization Using High-Conductivity Membranes

(71) Applicant: NRGTEK, INC., Orange, CA (US)

(72) Inventor: Subramanian Iyer, Orange, CA (US)

(73) Assignee: NRGTEK, INC., Orange, CA (US)

(21) Appl. No.: 15/153,688

(22) Filed: May 12, 2016

Related U.S. Application Data
(60) Provisional application No. 62/253,661, filed on Nov. 10, 2015.

(51) Int. Cl. C02F 9/00; B01D 61/44; B01D 61/58; B01D 61/00

(52) U.S. Cl. CPC C02F 9/00; B01D 61/002; B01D 61/44; B01D 61/58; C02F 2103/08

(57) ABSTRACT

Fluid desalination systems that include an FO reactor and an electrodeionization reactor with improved membranes and solvents, and a method of using such systems, are provided. A fluid having a first salt concentration is directed to the FO reactor, which uses a solute to draw salt away from the fluid across a membrane into the solute, where the electrodeionization reactor is salinized solute fluid and (i) generate substantially desalinated fluid and (ii) regenerate the solute for return to the forward osmosis reactor. The electrodeionization reactor is configured to draw positive and negative ions of the solute across cationic and anionic membranes, respectively, by applying a voltage across electrodes sandwiching the cationic and anionic membranes. In some cases, the cationic and anionic membranes are porous gelled polymer electrolyte membranes, wherein a saturated solution of the salinized solute fluid is absorbed.

### CORRESPONDING PATENT APPLICATION

The present application takes priority from provisional application Ser. No. 62/253,661 filed Nov. 10, 2015, the entire contents of which are incorporated herein in its entirety by reference.

### BACKGROUND

There are several methods for water desalination and purification, including distillation, reverse and forward osmosis, electrodeionization ED (e.g., electrodialysis reversal—EDR), ion exchange and freeze separation processes. FIG. 1 illustrates some characteristics of various techniques.

Distillation is the process of boiling water in order to form steam which is then cooled and condensed, produces water at a purity of 99.5%. Either MSF or MED systems are used for treatment of saline water. All of the solids and other materials that do not boil out with the water are left behind and only nearly pure water is extracted. Of these treatment methods, distillation is the oldest and most energy-inefficient. The latent heat of vaporization for water is high (˜40 kJ/mole) making this process extremely energy intensive. On the other hand, the advantages are the reduced volume of high-TDS content waste streams, and high purity treated water.

With reverse osmosis, this process extensively removes dissolved salts by forcing high TDS content water at high pressures (500-1,000 psig, depending on the TDS levels of the raw water) through reinforced semi-permeable membranes made of various polymer materials. The capital costs of an RO system can be high, and the membranes, which are expensive to replace, are susceptible to fouling and have a lifespan of about 7 years. Special ultrafiltration and other processes need to precede the RO process to prevent fouling and increase RO membrane life cycles. Typically, RO is the most energy-efficient processes for desalination, especially if energy recovery devices are used.

In ED/EDR, ions dissolved in water (Na⁺, Cl⁻) are attracted to electrodes of opposing electrical charges. Separate cationic and anionic membranes are placed in an alternative arrangement on top of the electrodes to separate the ions. In order to prevent membrane fouling, the polarities of the electrodes are reversed 3-4 times/hour. EDR is not a stand-alone water treatment process and does not effectively reduce the content of organic molecules in produced water. Ion exchange in some ways is related to EDR in that it takes advantage of the properties of charged particles. The difference is that anion and cation resins are placed into the water to be treated and H⁺ and OH⁻ ions replace the ions in the water. When the resin is depleted, a new resin bed is inserted. Like EDR, this process does not remove organic molecules from water. The chemical costs of this process also can be quite high.

Freeze separation processes are often employed in cold climates, especially in treatment of produced water from oil and gas operations. Freeze Thaw Evaporation (FTE) which is utilized for treatment of CBM produced water in Alaska, Colorado and Wyoming involves the storage of produced water until ambient temperatures drop below freezing. The water is pumped from storage onto a frozen pad with sprinklers. The higher TDS content water does not freeze and is drained and separated with the use of conductivity-controlled valves. The disadvantages to this process are that very low temperatures and substantial storage volumes are required in order to make it economical. Also, variable ambient temperatures and large amounts of snowfall cause complications.

The theoretical energy needed for seawater desalination can be calculated from first principles. Thermodynamic principles state that any method of water desalination will be most efficient, if it involves a reversible thermodynamic process. The same energy is invested in any reversible desalination process, and it is independent of the detailed technology employed, exact mechanism, or number of process stages. Osmosis is, in principle, a reversible process, though, its application deviates from reversibility. Osmosis is the phenomenon of water flow through a semi permeable membrane that blocks the transport of salts through it. The external pressure on the salt solution determines the speed and direction of water flow through the membrane.

For a vessel separated into two halves by a semi-permeable membrane, wherein the membrane only allows water transport, but rejects dissolved solids, like salts and organics, the osmotic pressure can be used to calculate the energy required to separate the salt from water. The force acting on the partition is equal to the osmotic pressure multiplied by the partition area. The osmotic pressure π is given by Van't Hoff formula: π=cRT, where c is the molar concentration of the salt ions, R=0.082 (liter·bar)/(deg·mol), is the gas constant, and T=300 K is the ambient temperature on the absolute temperature scale (° Kelvin).

The amount of salt in seawater is about 33 gram/liter. Seawater contains a variety of salts, but the calculation can be simplified by assuming that all the salt is sodium chloride (NaCl). The atomic weight of sodium is 23 gram, and of chlorine is 35.5 gram, so the molecular weight of NaCl is 58.5 gram. The number of NaCl moles in seawater is, therefore, 33/58.5=0.564 mol/liter. When NaCl salt dissolves in water it dissociates into Na⁺ and Cl⁻ ions. There are two ions per salt molecule, so the ionic concentration is twice the molecular concentration.

Thus, c=2.0×0.564=1.128 mol/liter. Inserting the values into the van′t Hoff formula yields the osmotic pressure: π=1.128×0.082×300=27.8 bar (or 27.8 kilogram per square centimeter). Assuming the semi-permeable membrane has a surface area of 1 square centimeter, to push 1 liter of water through the membrane, the water has to travel 1,000 centimeters (or 10 meters) across the membrane, while rejecting the salt by working against its osmotic pressure.

The work done (or the energy required) can be calculated: W=F·x=27.8×10=278 kg-meter/liter, (or 2780 Joules/liter, as 10 Joules are equal to 1 kg·meter). Similarly, 2780/3600=0.77 (kWatt-hour/(cubic meter). One kilocalorie (kcal) is equal to about 4200 Joules, therefore, the work is 2780/4200=0.66 kcal/liter. Thus, 0.66 kcal/liter is the minimum energy required to desalination of one liter of seawater, regardless of the technology applied to the process. This assumes full reversibility, i.e., 0% water recovery. Practical desalination systems are never fully reversible and there are energy losses that are due to unavoidable irreversible contributions. These losses, that depend on the water recovery ratio, increase the energy of desalination above the reversible thermodynamic limit. Thus, for 50% recovery of fresh water from seawater, the minimum theoretical energy is 1.06 kWh/m³. In addition, energy is consumed for pre-treatment, increased pressure needs to compensate for fouling, post-treatment needs like boron and chloride removal, as well as pumping energy for intake and discharge pipes. All of these causes the most efficient Reverse Osmosis process to consume about 2.0-2.5 kWh/m³ in energy costs. A two-stage RO system can reduce the energy costs but increases capital costs. Thus, the practical minimum energy requirement for a single-stage RO is 1.56 kWh/m³, while for a two-stage RO, it is 1.28 kWh/m³. Only for an infinite number of stages does RO energy costs come close to the theoretical minimum of 1.06 kWh/m³ for 50% water recovery from 35,000 TDS seawater.

It is interesting to compare this energy to the heat required to boil one liter of water and condense its vapors. About 70 kcal are required to heat one liter from room temperature to the boiling temperature, then another 540 kcal are required to convert it to water vapor. Most of the invested heat comes back during condensation and a lot of it is recoverable by use of heat exchangers. Yet it seems difficult to compete with the energy efficiency of desalination by reverse osmosis.

Another interesting corollary from the above calculation results if, instead of water being transported across the membrane, a mechanism can be found to transport salt across the membrane. Thus, the membrane rejects most of the water, but allows the salt to pass through. If it is assumed that the salt will be always associated with some water, up to its saturation limit, given the maximum solubility of NaCl in water is 359 g/liter, and given the concentration of 35 gms of NaCl in 1 liter of seawater, a volume of only 0.1 liter of the saturated salt solution will need to be transferred across the membrane. If such a mechanism for salt removal can be perfected, the theoretical energy for desalination can possibly be reduced by a factor of 10, i.e., 0.077 kWh/cu³ in a reversible process.

Several companies have worked on high permeability membranes as an answer to the required energy for commercial desalination plants. New high-flux membranes, based on carbon nanotubes (Porifera Inc.) and bio-inspired Aquaporin membranes have been proposed, and are actively being investigated. However, the required energy for desalination is dependent on the osmotic pressure of the concentrate, and higher flux membranes will do little to reduce the required energy, though they may have an impact on the capital costs of the RO plant.

Forward osmosis (FO) is a new process technology being explored for desalination of seawater and produced water from oil and gas fields. Unlike reverse osmosis (RO) processes, which employ high pressures ranging from 400-1100 psi to drive fresh water through the membrane, forward osmosis uses the natural osmotic pressures of salt solutions to effect fresh water separation. A “draw solution”, having a significantly higher osmotic pressure than the saline feed-water, flows along the permeate side of the membrane, and water naturally transports itself across the membrane by osmosis. FO also does not require extensive pretreatment, since the low pressures minimize fouling of the membranes.

Osmotic driving forces in FO can be significantly greater than hydraulic driving forces in RO, leading to higher water flux rates and recoveries. Thus, it is a non-pressurized system, allowing design with lighter, compact, and less expensive materials. These factors translate to savings both in capital and operational costs. Energy represents about 40% of the costs of RO desalination, (and around 80% of the costs of thermal desalination) and is projected to increase with the upward trend in energy prices. In addition, the lower amount of more highly concentrated reject brine produced by FO processes is also more easily managed. Several FO processes have been proposed, using either volatile solutes like ammonium carbonate/bicarbonate (Oasys LLC), sulfur dioxide or aliphatic alcohols, or perceptible salts like aluminum sulfate/calcium hydroxide/magnesium chloride (Modern Water Ltd, with evaporative cooling downstream of the FO process to regenerate the osmotic agents). Glucose has been used as solute for the draw solution, which can then be ingested after suitable dilution (HTI Inc.). Another area of current research in forward osmosis involves indirect removal of draw solutes, in this case by means of magnetic fields. The main energy consumption in these processes involves the energy expended in recovering and recycling these ‘osmotic draw agents’. Any draw agent that minimizes this energy expenditure would make the FO process extremely competitive with current desalination processes like RO or thermal distillation techniques. Waste heat or evaporative cooling as main energy sources for main energy source for desalination are some methods being actively investigated for FO processes.

Ammonium bicarbonate (NH₄HCO₃) as the draw solute for seawater desalination by the FO process has been attempted and cited in literature. The solute recovery is done by thermal means, since ammonium bicarbonate breaks down into ammonia and carbon dioxide at temperatures of around 60-65° C. These gases are subsequently recombined and dissolved in water to replenish the concentrated draw solution for recycling to the FO loop. Similarly, magnesium chloride has also been used as the draw solute for FO processes, and is regenerated to its concentrated form by evaporative cooling for recycling to the FO loop.

Studies with ammonium bicarbonate (NH₄HCO₃) as the draw solute for seawater desalination by the FO process, however, has shown inordinate amounts of NH₄HCO₃ being lost into the raw feed water, due to the reverse flow of bicarbonate ions into the feed, resulting in steadily increasing pH in the feed. This becomes a practical issue for implementation of FO with NH₄HCO₃ as the osmotic agent: the loss of draw solute through the membrane into the feed. The cost implication is that a municipal scale FO plant with capacity of 100,000 m³/day will lose at least 200,000 kg of NH₄HCO₃ on a per day basis, which would also need replenishment. Additional production costs for topping-up of the loss of NH₄HCO₃ will be $0.4/m3 if NH₄HCO₃ cost is $0.2/kg. This has been a challenge to the FO research community, and particularly Oasys Inc. Future development of NH₄HCO₃ solutes for FO applications needs to take into account the interdependent relationship between membrane development and draw solution selection, and under the consideration of cost-effectiveness. This limitation needs to be addressed via greater enhancement of FO membrane performance, simultaneously with higher water permeability and much higher solute selectivity, such that Js/Jw≦0.01 g/L. Commonly used FO processes, using NH₄HCO₃, typically regenerate the salt by utilization of waste heat, which breaks down the salt into ammonia and carbon dioxide at 60-65° C. These gases are recombined to again form concentrates of the ammonium bicarbonate solution for recycling in the FO process. However, for small and compact practical portable system, compact heat exchangers and waste heat recovery devices would be needed.

NRGTEK had developed an innovative, low-energy (≦1.0-1.5 kWh/m³), ‘forward-osmosis’ (FO) based desalination process, which compares very favorably in energy consumption to traditional water purification/desalination processes like reverse osmosis (˜2.0-3.5 kWh/m³) and thermal distillation (15-25 kWh/m³), for desalination of highly saline waters. The process is applicable to both seawater desalination, brackish water desalination and ‘produced’ water treatment for the oil and gas sector.

The patented NRGTEK FO process made use of novel organic, hydrophilic-lipophilic, specifically engineered oligomers, capable of high osmotic pressures in aqueous solutions, and thus able to extract water from saline waters (seawater, brackish water, water from hydraulic fracturing operations in the oil and gas sectors like ‘frac blowback water’ and ‘produced water’, and industrial waste waters), with high recovery rates. The recovery of these ‘osmotic agents’ is effected by a ‘cloud-point’ phenomena, which causes a phase separation of these agents from its aqueous solution with increases in temperature. NRGTEK has been able to initiate cloud-point separation by specially engineering these polymers, as well as by addition of cloud-point depression agents, post FO processing, to within 1.5-2° C. of the inlet saline water stream. Since water essentially consumes an energy of 1 kWh/m³ for each 1° C. increase in temperature, this reduces the FO energy requirements (other than pumping costs) to less than 2 kWh/m³, almost 30% lower than the most energy efficient RO process currently in use.

Referring to FIG. 2, another process of interest for small compact systems is electrochemical desalination (ED/CEDI). ED is a well-established method for the removal of electrolytes from aqueous solutions. It involves the preferential transport of ions through ion exchange membranes under the influence of an electrical field, producing concentrated brines and salt-depleted waters. It is conventionally used for treatment of low-TDS brackish water, though desalination of water with higher concentrations of dissolved salts (30,000-100,000 ppm) to potable water can be also be achieved by ED but at higher energy costs. Other technologies using electrical current for salt removal include capacitive deionization systems (CDI), also called a Flow Through Capacitor (FTC). An example of a primary mass transfer mechanism for technologies involving the type of flow through capacitor systems described above is the FTC device described in U.S. Pat. No. 6,709,560 to Andelman, which operates by diffusion through a membrane brought about by an electrical charge density gradient.

Ion exchanging resins have been used to produce deionized water. These ion exchanging resins generally require chemical regeneration. On-site ion exchange regeneration requires aggressive chemicals that are dangerous to handle. Removal of the spent chemicals must be dealt with in a manner that is safe for the environment. In this respect, attention has been drawn in recent years to a self-regenerating type deionizing apparatus. To avoid the use of aggressive chemicals, a deionizing function of the ion exchanging resins and an electrodialysis function of ion exchange membranes are combined in an electrodeionization apparatus to obtain high-purity deionized water without chemical regeneration, as is discussed in U.S. Pat. No. 6,274,019. Electrodeionization is a water purification technique that utilizes ion exchanging resins, ion exchange membranes, and electricity to deionize water, as is discussed in Wilkins, F. C., and McConnelee, P. A., “Continuous Deionization in the Preparation of Micro-electronics Grade Water”, Solid State Technology, pp 87-92 (August 1988). Electrodeionization is differentiated from electrodialysis by the presence of ion exchange resin in the purifying compartments. A discussion of electrodialysis and ion exchanging resins to purify saline water are described in U.S. Pat. Nos. 2,796,395, 2,947,688, 2,923,674, 3,014,855, 3,384,568, and 4,165,273, for example.

Ions entering the resin-filled purifying compartment transfer through the resin and the ion exchange membranes in the direction of the electrical potential gradient, into the concentrating compartment. See Liang, L. S., Wood, J., and Hass W., “Design and Performance of Electrodeionization System in Power Plant Applications”, Ultrapure Water pp, 41-48, (October 1992). As a result, ions in the water will become depleted in the purifying compartments and will be concentrated in the adjacent concentrating compartments. The third stream is the electrode stream that sweeps past the electrodes removing gases from electrode reactions as it flows. The percentage of the incoming feed water that becomes purified product is referred to as the recovery of the system. In conventional electrodeionization systems with reverse osmosis product as feed, the concentrate stream can typically be re-circulated to obtain recoveries in the range of 80 to 95%. U.S. Pat. No. 6,193,869 discloses the use of modular system design.

Commercial EDI/CEDI systems are usually used to purify the permeates from single-stage or dual-stage RO system to remove any remaining TDS to produce ultrapure water for use in the pharmaceutical or electronic industries. Thus, they inherently start off from a very low TDS value. However, there have been some reports of successful treatment of brackish water (5,000 TDS) to ultrapure water.

In 2007, Singapore issued a challenge for seawater desalination technologies: an energy requirement of 1.5 kWh/m3 of water produced. Siemens Water Technologies (currently Evoqua Water Technologies) were judged the only winner for the challenge, and proposed an EDI/CEDI (Electrodeionization/Continuous Electrodeionization) technology to reach the challenging goal. EDI/CEDI is a variation of the more common ED-R process, wherein electrode polarity reversal is not needed due to the use of ionic resins, in addition to ionic membranes.

In their efforts to desalination 35,000 TDS water to less than 500 TDS potable water, Siemens encountered several technical issues, ranging from lack of commercially available membranes and their inability to efficiently sequester salt ions, to issues with other membrane properties, as identified in FIG. 3. Water recovery rates were found to affected by osmotic effects, ion hydration and water losses due to hydraulic issues. The combined effect of the same was to increase the energy consumption of the EDI/CEDI process to around 1.8 kWh/m³.

The typical resin fouling and membrane scaling problems of electrodeionization systems remain unalleviated for seawater desalination. Presently described electrodeionization apparatus remain unsuitable for desalination and are currently only used for the production of ultra-high purity water. Hard waters, silica-containing waters and highly saline brackish waters, and waters containing colloidal particles and fouling agents still represent liquids that cannot be consistently and reliably purified by presently known electrodeionization apparatus and modes of operation. Extensive maintenance and cleaning of these apparatus remains necessary, the quality and volume of the purified liquids remains erratic and the ability to produce at least 1 meg-ohm centimeter of quality water consistently and in sufficient volume remains unachieved.

One disadvantage of electrodeionization systems in general, is that they are typically complex structurally and functionally, often requiring pretreatment to work efficiently. Such systems are normally used as a “polishing” technology, requiring softened water and the prior removal of ions using reverse osmosis as a preferred pretreatment. Similarly, in capacitive deionization, one disadvantage of the use of a flow through capacitor (FTC) in a charge barrier format is the susceptibility to fouling that such systems often have. This problem occurs because during the regeneration process, the ions cannot be fully expelled as a result of becoming trapped in between the electrodes and the membranes. An example of a primary mass transfer mechanism for technologies involving the type of flow through capacitor systems described above is the FTC device described in U.S. Pat. No. 6,709,560 to Andelman, which operates by diffusion through a membrane brought about by an electrical charge density gradient. The system described in Andelman then involves (as a secondary mechanism) absorption onto the electrode during purification. The system described in the above cited U.S. patent issued to Andelman provides for flow through capacitors with one or more charge barrier layers. In these FTC devices, ions that are trapped in the pore volume of the flow through capacitors cause inefficiencies as these ions are expelled during the charge cycle into the purification path. In Andelman, a charge barrier layer holds these pore volume ions to one side of a desired flow stream, with the intent of increasing the efficiency with which the flow through capacitor purifies or concentrates ions. During regeneration, however, there is an absence of the charge density gradient and the only mechanism to expel ions is diffusion. Opposite polarity is therefore used to change the charge from negative to positive thus releasing more ions from the surface. This process of expulsion, however, even with systems of the type described in Andelman, can require an extensive period of time.

Technologies characterized as electrodeionization include electrodialysis and continuous electrodeionization. In general, such nomenclature has traditionally referred to systems that use electrodes to transform electronic current (a flow of electrons) into ionic current (a flow of ions) by oxidation-reduction reactions at the anolyte and catholyte regions of the anodes and cathodes of a cell. In such systems, ionic current is used for deionization in ion-depleting compartments, and neither the anolyte chambers, the catholyte chambers, nor the oxidation-reduction products, participate in the deionization process. In order to avoid contamination and to allow multiple depletion compartments between electrodes, the ion-concentrating and ion-depleting compartments are generally separated from the anolyte and catholyte compartments. To minimize formation of oxidation-reduction products at the electrodes, electrodeionization devices typically comprise multiple layers of ion-concentrating and ion-depleting compartments, bracketed between pairs of end electrodes.

A further problem associated with both electrodeionization systems and flow through capacitor (FTC) systems involves the required structure and the ionic conductivity of the membranes utilized. When a membrane material is used in isolation in such systems it must be thicker and has a larger electrical resistance due to the backing material required for its mechanical support. It would be preferable to provide a mechanism for utilizing thinner, more conductive and more flow efficient membranes that still retain the necessary structural integrity to continue to provide the required surface area within the cell.

The ion exchanging materials are commonly mixtures of cation exchanging resins and anion exchanging resins (e.g., U.S. Pat. No. 4,632,745), but alternating layers of these resins have also been described (e.g., U.S. Pat. Nos. 5,858,191 and 5,308,467). Because of their ability to exchange counter-ions, ion exchange resins are electrically conductive. The resin-filled purifying compartments facilitate ion transfer along contiguous ion exchange beads by creating a low resistance electrical path, even in a highly purified solution with high resistivity (see Griffin C., “Advancements in the Use of Continuous Deionization in the Production of High-purity Water”, Ultrapure Water, pp 52-60, (November 1991). A path is developed through the ion exchange resin beads that is much lower in electrical resistance than the path through the surrounding bulk solution, thereby facilitating removal of ions from the device. Strongly dissociated ion exchanging resins have specific electrical resistances of order of magnitude about 100 ohm-cm, i.e., about the same as an aqueous solution containing about 0.1 gram-equivalent of sodium chloride per liter. U.S. Pat. No. 5,593,563 discloses the use of electron conductive particles such as metal particle and/or carbon particles in the cathode compartment. U.S. Pat. No. 5,868,915 discloses the use of chemical, temperature, and fouling resistant synthetic carbonaceous adsorbent particles (0.5-1.0 mm diameter) in either electrolyte compartments, purifying compartments, or concentrating compartments. It is important to note that the presence of gases, poor flow distribution, low temperature and/or low conductance liquids within the electrolyte compartments may be detrimental to electric current distribution, thereby reducing the efficiency of deionization.

Scaling has been found to occur in localized regions of electrodeionization apparatus, and particularly those where high pH is typically present. It is believed that the pH at the boundary layer increases with current. Therefore, the current needs to be maintained at a sufficiently low level to prevent or, at least ameliorate the incidence of scaling. If the current is too low, poor water quality is obtained. If the current is too high, the incidence of scaling increases (U.S. Pat. No. 6,365,023). One difficulty in utilizing electrodeionization apparatuses is the deposit of insoluble scale within the cathode compartment primarily due to the presence. of calcium, magnesium, and bicarbonate ions in the liquid, which contact the basic environment of the cathode compartment. Scaling can also occur in the concentrating compartments under conditions of high water recovery. In order for calcium carbonate to precipitate in solution the Langelier Saturation Index (LSI) has to be positive. In the cathode compartment the pH can be high enough for the LSI to be positive. The LSI of reverse osmosis product water is always negative. The LSI is even negative in the electrodeionization concentrate stream. Thus, on the basis of consideration of LSI alone, one would not expect the precipitation of calcium carbonate that occurs within concentrating compartments. This phenomenon is instead explainable upon local conditions (U.S. Pat. No. 6,296,751). When the electrodeionization apparatus is in operation, pH near a surface of the anion exchange membrane locally becomes alkaline. Thus, all calcium or magnesium carbonate/bicarbonate salt in the solution needs to be eliminated prior to using the electrodeionization process, to prevent scaling and membrane inefficiency.

### SUMMARY

Embodiments of the present invention comprise systems that take advantage of the very low energy requirements of a forward osmosis system for water desalination or purification, combined with a continuous electrodeionization system with improved high-conductivity membranes, for production of pure water and regeneration of the draw solution for the forward osmosis cycle. If an EDI process with high-conductivity membranes is supplemented downstream to a forward osmosis (FO) process, the energy consumption of EDI remains within manageable levels, because the desalination is primarily effected by the FO membranes, and the electrolyte still retains sufficient electrochemical conductivity for movement of ions, without inordinate resistance or concentration polarization effects. In addition, the problem of membrane fouling or resin fouling is alleviated, as only the diluted draw solution from the FO process is fed to the EDI process, without organics, calcium and magnesium carbonates/bicarbonates, and other fouling contaminants detrimental to the feed for the EDI. The end result is a very low volume of concentrated brine (˜25%) as the effluent, ideal for re-use as the draw solution concentrate for the upstream FO process. and with almost 70-75% of the incoming permeate from the FO process, as the diluted draw solution, converted to water treated to environmentally useable levels, at economic costs lower than the competing processes of thermal distillation (MED, MSF or Mechanical Vapor Compression), RO and others (see Table A). There would be no need for waste heat or low value heat for draw agent regeneration and recycling to the FO system, as is common to current FO systems.

The integration of the EDI/CEDI process downstream to the FO process also enables use of various osmotic agents as the concentrated draw solution for the FO process. Thus, calculating from first principles, an ammonium chloride solution has an osmotic potential of 184.446 atms for a 20% solution in water, as compared to seawater (35,000 TDS) of only 28 atms. Magnesium chloride with a 20% concentration in water has an osmotic potential of 157 atms. A 20% ammonium bicarbonate solution in water has an osmotic potential of 125 atms. All of these can be used as osmotic draw agents, and the diluted draw solution from the FO process re-concentrated back to 20% by using the EDI/CEDI process to achieve the original concentration required for the FO process by using specially formulated high-conductivity membranes.

In one embodiment, a system is provided for the desalination of fluid having a first salt concentration therein, where the system comprises a forward osmosis reactor and an electrodeionization reactor in fluid communication therewith, where the forward osmosis reactor is configured to take the fluid having the first salt concentration into a first intake port in order to generate a fluid having a higher second salt concentration by directing into a second intake port a fluid having a first solute concentration with a higher osmotic pressure than the fluid having the first salt concentration in order to draw fluid having substantially no salt concentration across a membrane from the fluid having the first salt concentration so as to generate a fluid having a lower second solute concentration, and where the electrodeionization reactor is configured to take the fluid having the lower second solute concentration and (i) generate substantially desalinated fluid and (ii) regenerate the fluid having substantially the first solute concentration for return to the second intake port of the forward osmosis reactor, the electrodeionization reactor further configured to draw positive and negative ions in the fluid having the lower second solute concentration fluid across cationic and anionic membranes, respectively, by applying a voltage across electrodes sandwiching the cationic and anionic membranes. In one embodiment, the positive and negative ions in the fluid are those associated with the solute, such that the positive and negative ions can be recombined to substantially regenerate the fluid having the first solute concentration.

In one embodiment, the electrodeionization reactor comprises a continuous electrodeionization reactor configured to introduce cation and anion resin into the fluid having the lower second solute concentration to permit substantially continuous operation of the continuation electrodeionization reactor. The solute may comprise an ionic salt, such as for example, ammonia chloride, ammonium bicarbonate or magnesium chloride, a cloud-point solute, or a water-soluble polymer with high osmotic potential, such as non-cloud-point organic polymers like polyethylene glycols, polypropylene glycols and their derivative organic salts. In some embodiments, where the solute comprises an ionic salt, it can be beneficial for the anionic and cationic membranes to be porous polymer gelled electrolyte membranes comprising a substantially saturated solution of the ionic salt.

In another embodiment, a method is provided for desalinating fluid having a first salt concentration therein, where the method comprises directing into a first intake port of a forward osmosis reactor the fluid having the first salt concentration, and further directing the fluid having a first salt concentration passed a first side of a forward osmosis membrane within the forward osmosis reactor; directing into a second intake port of the forward osmosis reactor a fluid having a first solute concentration, and further directing the fluid having the first solute concentration passed a second side of the forward osmosis membrane, where the fluid having the first solute concentration has a higher osmotic pressure than the fluid having the first salt concentration, so as to draw across the membrane fluid having substantially no salt concentration to thus generate a fluid having a lower second solute concentration; directing the fluid having the lower second solute concentration between a cationic membrane and an anionic membrane positioned between electrodes; applying a voltage across the electrodes so as to draw positive and negative ions across the cationic membrane and anionic membrane, respectively, thereby generating substantially desalinated fluid. In one application, the positive and negative ions are those associated with the solute, and wherein the method further comprises recombining the positive and negative ions of the solute to regenerate fluid having substantially the first solute concentration for return to the second intake port of the forward osmosis reactor. In another embodiment, the method may comprise introducing cation and anion resin into the fluid having the lower second solute concentration to permit substantially continuous operation of the continuation electrodeionization reactor. The solute may be as described by example above. In some embodiments, where the solute comprises an ionic salt, it can be beneficial for the anionic and cationic membranes to be porous gelled polymer electrolyte membrane comprising a substantially saturated solution of the ionic salt.

### BRIEF DESCRIPTION OF THE FIGURES

The aforementioned objects and advantages of the present invention, as well as additional objects and advantages thereof, will be more fully understood hereinafter as a result of a detailed description of a preferred embodiment when taken in conjunction with the following drawings in which:

FIG. 1 identifies the types and characteristics of various prior art desalination processes;

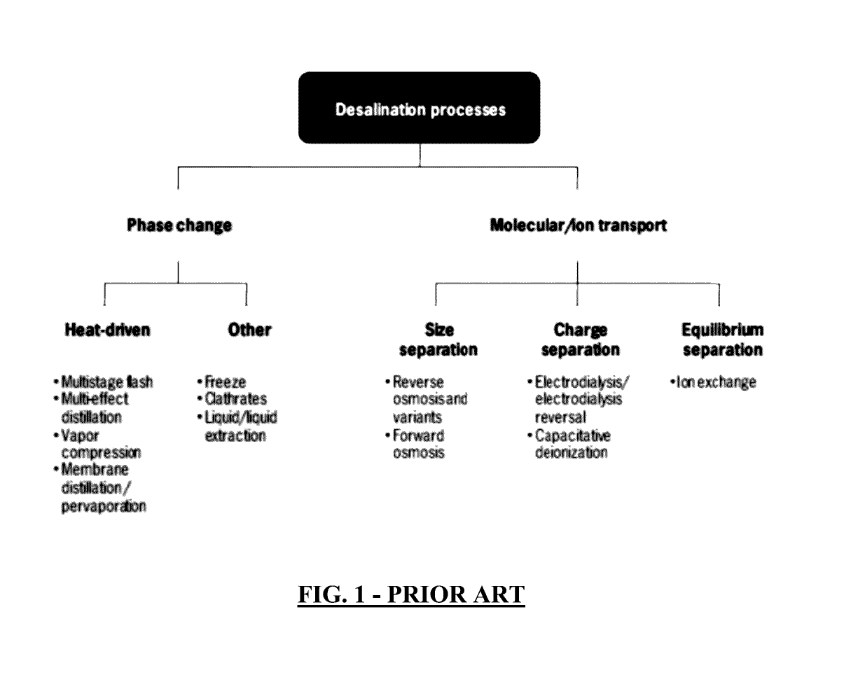

FIG. 2 shows schematically one example of electrochemical desalination (ED) technology;

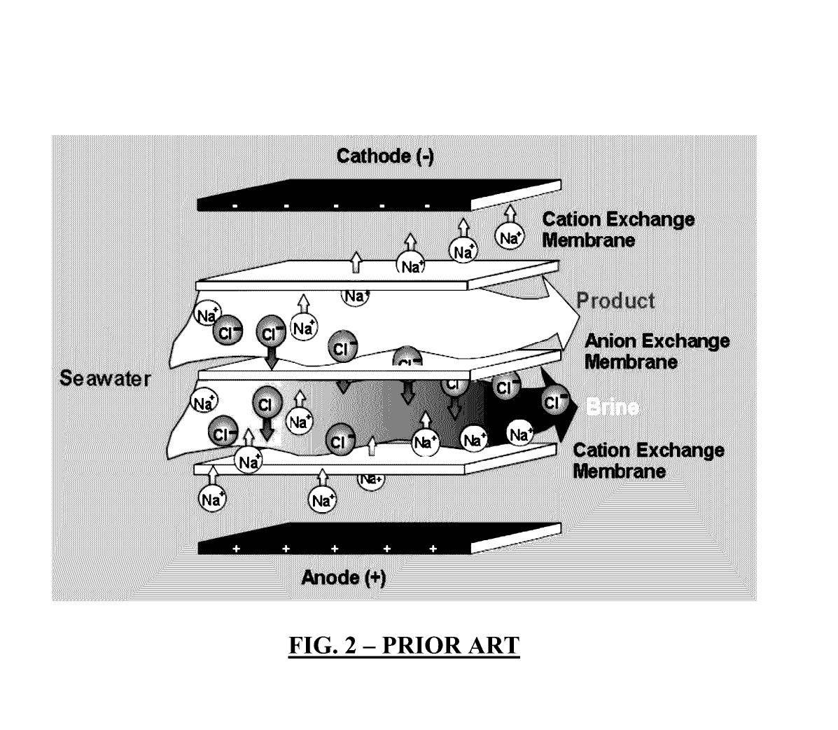

FIG. 3 shows schematically the water transport inefficiencies in current ED processes;

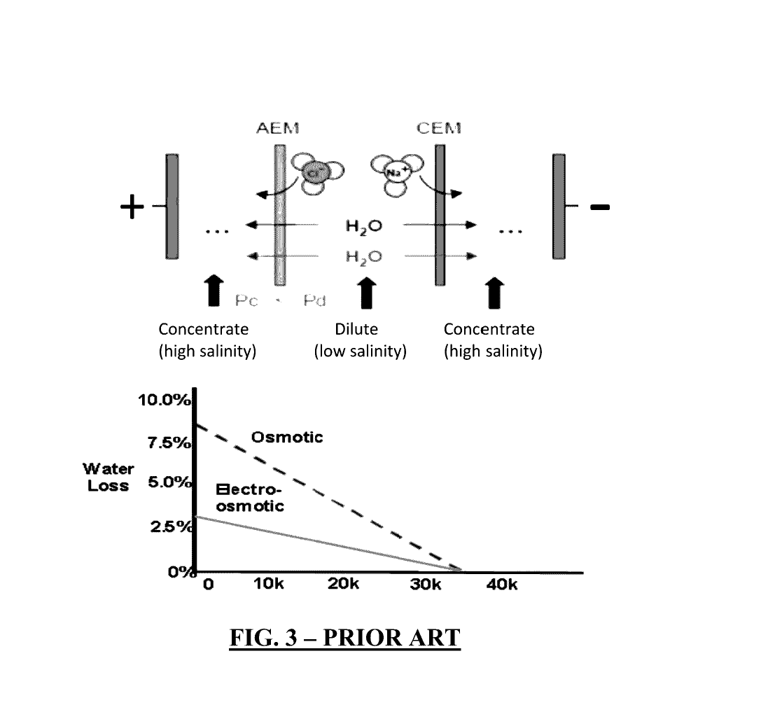

FIG. 4 shows schematically one embodiment of the present invention for use, for example, with an ionic solute;

FIG. 5 shows schematically one cell of the ED system of FIG. 4 and the separation of ions of the solute into adjacent cells;

FIG. 6 shows schematically an alternative embodiment of the present invention for use, for example, with a water-soluble polymer solute; and

FIG. 7 shows schematically one cell of the ED system of FIG. 6 and the separation of water ions while using a non-ionic polymer draw solute.

### DETAILED DESCRIPTION OF CERTAIN EMBODIMENTS

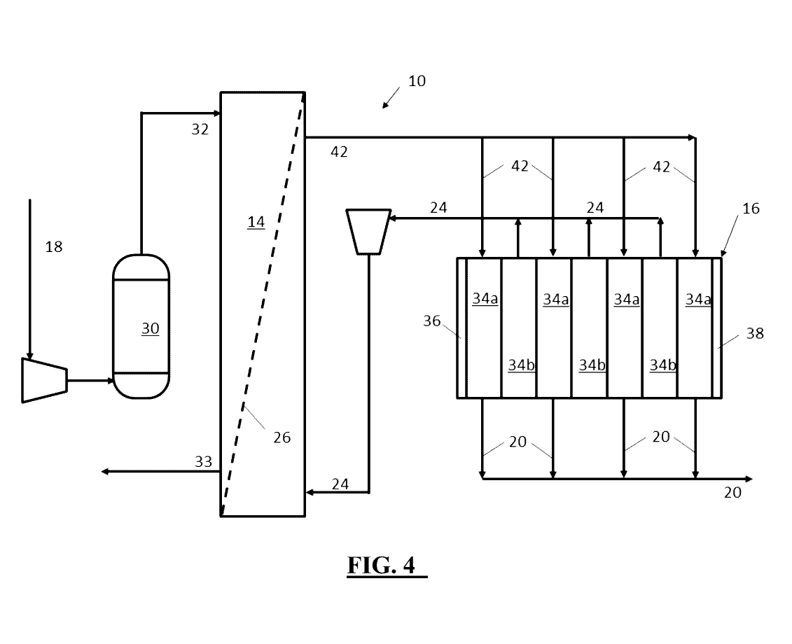

Referring to FIG. 4, in one embodiment of the present invention, a system 10 is provided comprising a forward osmosis (FO) reactor 14 coupled to a downstream electrodeionization (EDI) reactor 16 (preferably a continuous electrodeionization (CEDI) reactor). The two are combined for the desalination of fluid 18 having a heavier than desired salt content, such as seawater, brackish water, industrial water or wastewater, to produce potable water 20. The FO reactor 14 preferably utilizes a solvent 24 having a generally high osmotic potential in solution that can be used to draw salt from the fluid 18 across membrane 26 within the FO reactor 14.

Any ionized salt which gives a high osmotic potential in its solution in water, can be used as the draw solution for the forward osmosis process. Examples of preferred salts include ammonium chloride, magnesium chloride, ammonium bicarbonate or ammonium carbonate. The downstream continuous electrodeionization enables recovery of the draw solution as a concentrated ionic solution in water, along with potable water as the main product. The use of a reverse CEDI process also enables use of non-ionic polymeric draw solutions, with high osmotic potentials, to also be used for the FO process, with regeneration of the concentrated polymer solution for recycling to the FO process and a stream of pure water as the permeated product. The use of a FO-CEDI process consumes much lower energy than reverse osmosis or thermal desalination, without issues with membrane fouling or bio-fouling, which plagues the reverse osmosis process, unless efficient pretreatment with ultra-filtration membranes is carried out prior to reverse osmosis processes.

In the example embodiment of FIG. 4, raw fluid having high saline content 18 enters a pre-filter 30, where particulates and suspended solids are removed. The result is filtered salt water 32 that is directed into the forward osmosis module 14, where water in the salt water 32 is removed due to osmotic gradients across the FO membrane 26. A solution 24 of solvent, for example, ionic hydrolytic agents, creates the necessary osmotic gradient across the FO membrane 26, although many type of solvents are contemplated, as discussed herein. A concentrated saline fluid 33 is carried away from the FO module 14 for disposal or use. The removal of water from the input raw saline water 32 converts the concentrated draw solution to a diluted draw solution 24, which is then sent to the EDI system 16, which comprises a plurality of cells 34a and 34b sandwiched between an cathode 36 and anode 38, explained in more detail below. In some embodiments, the EDI system 16 can is a continuous electrodeionization system (CEDI). Under a small applied voltage, typically 0.4-0.8 Volts/cell, the ionic draw solution is re-concentrated for supply to the FO module, and a pure stream of potable water is made available for human consumption. The diluted draw solution 42 is directed into the CEDI reactor 16 to separate the solvent 24 from clean water 20.

Forward osmosis, using for example ionic salts as the draw solute, enable substantially pure water-salt solutions to be sent down-stream to the EDI process, which alleviates membrane fouling and associated maintenance issues in the EDI system. Thus, the EDI process works at close to ideal efficiency. A newer process, called CEDI (continuous electrodeionization), also includes anionic and cationic exchange resins in the main electrode compartments, in addition to the anionic and cationic membranes lining the periphery of the cells. As the salts ions are transported across the respective membranes, typically at a voltage of around 0.4-0.6 V/cell, the conductivity of the solution decreases, leading to higher amperage needs and corresponding resistance effects. Operating the cell as a higher voltage, around 0.8 V/cell, allows water to break down into H+ and OH− ions, which interact with the ion exchange resins in the cell, and restore ionic conductivity in the solution. Thus, the resins acts as a ionic pathway across each individual cell, keeping cell amperage and resistance low. The process is termed continuous, since the resins continuously get regenerated, there is no need for electrode polarity reversal, and product output is constant. Typical operating numbers for a CEDI system operating downstream of a dual RO system, to produce ultra-pure water for power generation, are a product rate of 9 m³/hr, for a CEDI power supply of 300 V, 16 A. This leads to a energy requirement of 0.53 kWh/m³ for highly purified water after initial water purification by reverse osmosis.

The preferred draw solutes would be suitable ionic salts, such as for example, ammonium bicarbonate, ammonium carbonate, magnesium chloride, calcium chloride, potassium chloride and sodium chloride salts. These salts have very high solubility in water and high osmotic potentials, as compared to NaCl and other salts commonly present in seawater and brackish water. Magnesium chloride is a strongly ionizable salt, while ammonium bicarbonate and ammonium carbonate are weakly ionized salts. Conversely, the low bonding strengths of ammonium bicarbonate and carbonate are low, since it can thermally be converted into ammonia and carbon dioxide at low temperatures, of around 60-65° C.

Magnesium chloride salt is one example of ionic hydrolytic agent, as shown in FIG. 4. It has excellent osmotic properties, as shown from laboratory experiments, well in excess of an equal concentration of NaCl. Thus, a 20% solution of MgCl₂ yields an osmotic pressure of almost 300 atms, as compared to 168.54 atms for an equivalent concentration of NaCl. Similarly, ammonium chloride solutions have even higher osmotic potentials, and would be very suitable draw agents for the FO process, while also retaining high electrochemical conductivity for the downstream CEDI process. An equivalent concentration of NH₄HCO₃ generates only 124.76 atms. Thus, NH₄Cl or MgCl₂ would be an excellent ionic hydrolytic agent for the FO process, if it can be cost-effectively regenerated for repeat cycles in the FO process. Fortunately, the ionicity of NH₄Cl or MgCl₂ and the use of an EDI process downstream of an FO process enables the efficient recycling of a concentrated NH₄Cl or MgCl₂ solution for continuous use in the FO process for water recovery. In addition, commonly used FO membranes would allow no cross-over of the osmotic agent to the feed side, since MgCl₂ is a bivalent salt, thus preventing any loss of the osmotic agent, unlike NH₄HCO₃ solutions. The MgCl₂ hexahydrate has a solubility of 167 g/100 ml of water, and is a cheaply and commercially available salt.

In addition, MgCl₂ solutions also serve as biocides and germicides, but still fit for human consumption in small amounts. This is an added advantage for emergency water supplies in remote areas with no need for chlorination or other biological disinfection systems.

NRGTEK Inc. has been working on FO-based desalination systems, though with different draw solutions, based on cloud-point polymers, using ethoxylate-butoxylate block-coplymers. NRGTEK synthesized several cloud-point polymers, based on glycerol ethoxylates and suitably butylated. All these polymers exhibited higher osmotic potentials, as tested against 20% MgCl₂ solutions, and were able to pull water from the MgCl₂ solution at good flux rates, across an HTI-CTA FO flat-sheet membrane. However, when run across a spiral-wound HTI-CTA FO membrane module, the very high viscosity of the polymers resulted in very low flux rates and water removal from the salt solutions.

A 20% MgCl₂ solution has an osmotic potential of 300 atms, compared to 28 atms for a 3.5% NaCl solution. Hence, water recovery rates across the membrane are excellent. It is estimated that the 20% MgCl₂ solution will need to go down to a 10% solution (OP=100 atms), while the 3.5% NaCl solution will go up to a 10.5% (OP=90 atms) solution before the osmotic potentials become close enough to prevent any significant water transfer. Thus, the water recovery from the feed solution is expected to be in the range of 75%, well in excess of commercial RO systems.

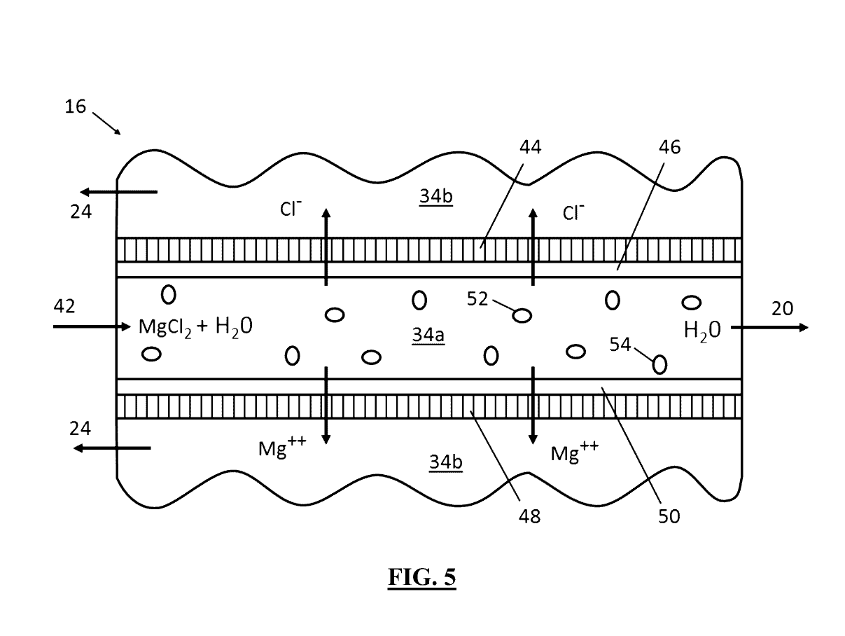

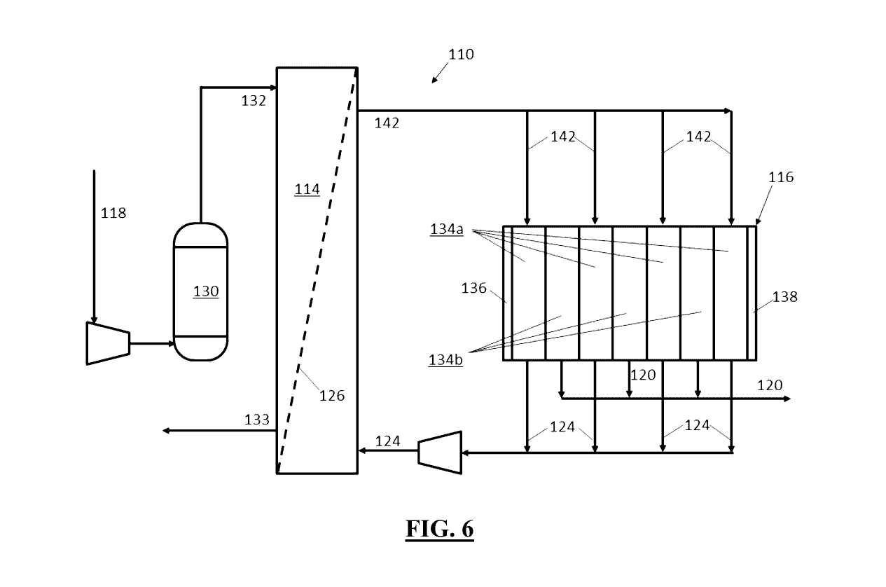

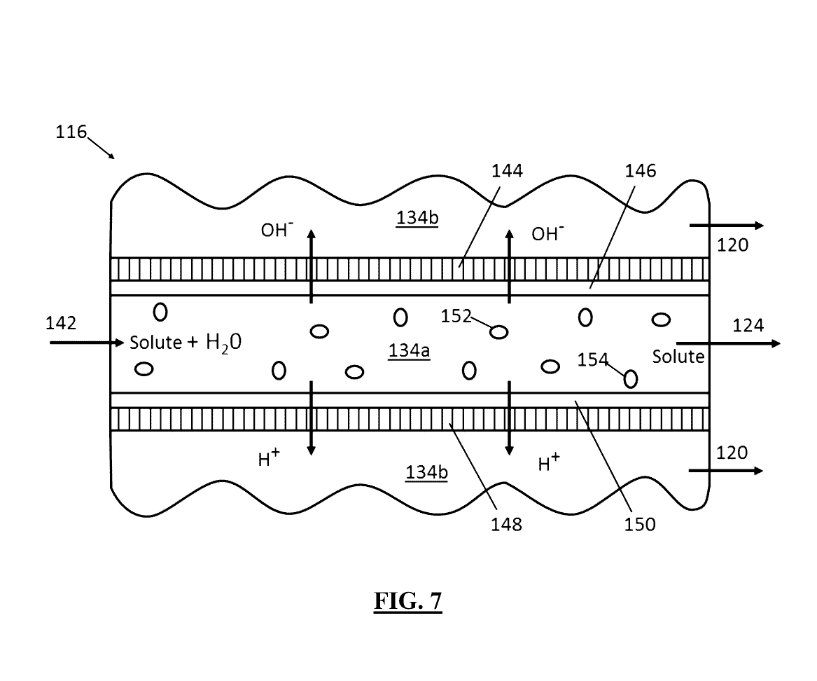

Referring to FIG. 5, an EDI system, preferably a continuous EDI system, is provided capable of concentrating a solute employed within the FO reactor 14. As discussed herein, the solute may be an ionic salt, for example, magnesium chloride, or a cloud-point solute, or a water-soluble polymer such as non-cloud-point ethoxylates and/or propoxylates. FIG. 5 illustrates use of an ionic salt as a solvent, whereas FIGS. 6 and 7 reflect use of a water-soluble polymer solute. In one example of a specific ionic salt, a 20% solution of MgCl₂ may be used to yield potable water for human consumption. Referring specifically to FIG. 5, a single cell 34a is provided (between adjacent cells 34b) for the introduction of diluted FO solvent (e.g., 10% solution of MgCl₂. The cell 34a is provided with an electrode mesh 44 and an anionic membrane 46, along one side of the cell, and an electrode mesh 48 and a cationic membrane 50, along the other side. The chloride ions are transported through the anionic 46 membrane to an adjacent cell 34b, and the magnesium ions are transported through the cationic membrane 50 to an opposing adjacent cell 34b, both under the influence of an electrical field (for example, approximately 0.4-0.6 VDC). Anionic 52 and cationic resin 54 may be provided to facilitate the transport process. The individual cationic and anionic exchange resins can be of several formulations; the cationic resin can be either in the protonic form (H+) or as an cationic ion format (Mg++ form or Na+ form). Similarly, the anionic exchange resin can be in the hydroxyl form (OH−) or an anionic ion format (Cl−). The individual anionic and cationic ions in the respective resins are the ions which are exchanged with the ions in the solute.

With multiple cells arranged in series to each other, as shown in FIG. 4, each of these adjacent cells containing the transported ions (e.g, the magnesium and chloride ions) recombine to form a concentrated magnesium chloride solutions for recycling to the FO module as a regenerated draw solution. The other cells from which these ions have been extracted now have substantially purified water, suitable for potable purposes.

Possible anionic and cationic membranes, which by example can be used for the multi-cell CEDI system, are listed in Table A below. These commercially available membranes are used for present-day CEDI systems, where ultra-pure water is produced after the process of reverse osmosis has initially purified the water and removed most of the salt, as well as other fouling agents from the raw water. However, for such membranes to be applied to the regeneration of a 20% MgCl₂ or NH₄Cl from the diluted permeate of a forward osmosis system, membranes with much higher conductivity and ion-exchange capacity are desirable.

TABLE A

| | Conductivity | Resistivity | Thickness | Areal Resist. |
|---|---|---|---|---|
| Membrane | (S/cm) | (Ω-cm) | (cm) | (Ω-cm²) = RA |
| Nafion NE-1135 | 0.10 min | 10 max | 0.0089 | 0.089 |
| Protonic | | | | |
| Nafion 115 | 0.10 min | 10 max | 0.127 | 0.127 |
| Protonic | | | | |
| Fumasep FAD | 0.013 | 76.92 | 0.010 | 0.7692 |
| Fumasep FAP | 0.006 | 166.67 | 0.007 | 1.167 |
| Excellion I-200 | 0.0034 | 294 | 0.034 | 9.996 |
| Membranes Intl | 0.00055 | 1818 | 0.0403 | 73.2654 |
| AM-7001 | | | | |
| Sybron Ultrex | 0.0016 | 625 | 0.0406 | 25.375 |
| MA-3475 | | | | |
| Tokuyama AM1 | 0.0056 | 178.57 | 0.016 | 1.2-2.0 |
| Tokuyama AFX | 0.0127 | 78.74 | 0.014 | 0.7-1.5 |
| Tokuyama AFN | 0.04 | 23.08 | 0.013 | 0.3-1.0 |
| Tokuyama A-010 | 0.018 | 55 | 0.004 | 0.22 |

The solid polymer membranes shown in Table A do not exhibit very high electrochemical conductivity for efficiently deionizing large amounts of salt without an energy penalty, nor do they have sufficient ion-exchange capacity for exchanging large amounts of salt ions. New membranes with much higher electrochemical conductivity and much higher ion-exchange capacity are desired. Such membranes, suitable for deionization of the FO permeate to pure water and regeneration of a concentrated FO draw solution, are described herewith.

In one embodiment, for example, porous polymer gelled liquid electrolyte membranes are provided that exhibit properties intermediate between liquid electrolytes and solids-state electrolyte membranes. These polymeric membranes have interconnected pores, filled with the desired electrolyte, which is held inside the pores by capillary forces. The pores are typically between 0.1-10 microns, or even smaller, and the porous polymer membrane may have a porosity between 85-90%, which is then filled with the desired liquid electrolyte by absorption. The polymers typically used for forming the porous membrane structures are well-known in literature, and range from polyethylene oxide (PEO), polyacrylonitrile (PAN), polydimethylsiloxane (PDMS), polyvinylidene difluoride (PVDF), poly(methyl-methlyacrylate) (PMMA) and other polymers. Some membranes cited in literature are also made from mixtures of these polymers with each other and other polymers. Thus, a few examples of porous membrane structures suitable for polymeric gelled electrolyte membranes are PVDF-HFP (PVDF-co-hexafluoropropylene) membranes, PDMS-PAN-PEO membranes, PVDF-NMP-EC-PC (PVDF with n-methylpyrolidine and ethylene and propylene carbonates), and even PVDF on glass mats. Such porous membranes, in which saturated solutions of MgCl₂ or NH₄Cl have been absorbed, would have much higher electrochemical conductivity and much higher ion-exchange capacity than conventional solid-state polymeric anionic and cationic membranes shown in Table A, especially for bivalent ions like magnesium ions. The ion exchange capacity for commercially available cationic and anionic ion-exchange membranes is only around 1.6-1.8 meq/g (milli-equivalents per gram), and a ten-fold to hundred-fold increase in ion-exchange capacity is desirable for energy-efficient EDI/CEDI. For example, magnesium chloride has a solubility in water in excess of 150 g/100 ml of water. This translates to a TDS (total dissolved solids) concentration of 1,500,000 ppm. Assuming the normal correlation of TDS with electrical conductivity (EC), at 500 ppm to 1,000 μS/cm, a saturated solution of MgCl₂ at a TDS level of 1,500,000 ppm computes to an electrical conductivity of 3 S/cm, a hundred-fold or higher than commercially available ionic membranes shown in Table A. If such a saturated solution can be used to make the porous polymeric gelled electrolyte ionic membranes, the presence of similar cations and anions, in a saturated solution inside the porous membrane architecture, also delivers very high ion-exchange capacity from one side of the membrane to the other, under the influence of an electrical voltage. The energy losses due to resistivity effects in the membranes in the CEDI system would also be substantially decreased. The fabrication of such a membrane is described herewith.

If the draw solution to be used for the FO process is MgCl₂, a porous polymeric gelled electrolyte membrane filled with saturated MgCl₂ solution can be used for both the anionic and the cationic sides in the subsequent CEDI process, instead of conventional anionic or cationic solid-state polymer membranes. Since the porous gelled MgCl₂ cationic membrane is now used for transport of Mg ions across the membrane in the CEDI system, and the porous gelled MgCl₂ anionic membrane is used for transport of chloride ions across the membrane in the CEDI system, the transport efficiency of these ions across their respective membranes are optimized, resulting in much higher ionic conductivity and ion-exchange capacity due to the saturated ionic solution filling the pores of the porous polymeric membrane scaffolding. A similar system is contemplated for CaCl₂, KCl, NaCl and NH₄Cl solutions, for example, if these solutions are alternatively used as the draw solution for the FO process. Such porous polymer gelled electrolyte membranes function as salt bridges with electrodes of suitable polarity attached to them to either enable anion or cation transport. No new ionic species are introduced into the system, and no other electrochemical or ionic interference effects takes place, since all the cells in the CEDI system contain the same ionic species, though in different concentrations in different cells in series. The equal impedance matching of these porous polymer gelled electrolyte membranes, if made by a procedure as described above, enables the minimization of polarization losses in the experimental cell, and the saturated nature of the solution filling the pores of the membrane enable high ion exchange capacity. The anode and cathode materials are platinized titanium meshes, in order to resist salt and chloride corrosion.

Referring back to FIG. 4, for example, the FO-CEDI system, when integrated together into a serial system, is capable of desalinating seawater, with at least a 75% water recovery, and with continuous regeneration of the draw solute for recycling to the FO module. In one example, if 100 liters of a saline salt solution, comprised of 3.5% NaCl (osmotic pressure of 28 atms) for example, is introduced into the feed side of a Forward Osmosis module, and 100 liters of a concentrated draw solution, comprised of 20% MgCl₂ (osmotic pressure of 300 atms) is introduced into the draw side of the Forward Osmosis module, the osmotic pressure differential is sufficient between the two solutions to enable withdrawal of at least 75 liters of water across the FO membrane, from the feed side to the draw side, at practical flux rates. This results in fresh water recovery of 75% from the initial 100 liters of the saline salt solution. The 175 liters of the draw solution from the FO system, now diluted down to 12.5% MgCl₂, is fed into a CEDI system, wherein the draw solution is re-concentrated back to 100 liters of a concentrated 20% MgCl₂ draw solution, for recycling back to the Forward Osmosis module, while also resulting in production of fresh potable water of 75 liters.

Referring to FIGS. 6 and 7, in another variation of the CEDI process, polymeric draw solutions, similar to the cloud-point polymers already developed by NRGTEK Inc. can also be used for the FO-CEDI process, with a small variation in the CEDI cell. In such an application, the diluted draw solution permeate 142 from the FO process, containing high osmotic potential polymeric draw solutions are fed to one of several CEDI cells 134a. The CEDI feed cell is filled with strongly cationic and strongly anionic ion exchange resins 152, 154, and a voltage of around 0.8 VDC impressed across each cell. At this voltage, water breaks down into OH⁻ and H⁺ ions, which are now transferred across the anionic membrane 146 and cationic membrane 150, respectively, to the adjacent permeate cells 134b due to the voltage gradient present, wherein they recombine into pure water, as shown in FIG. 7. In spite of the polymeric draw solution not having any ionic conductivity, the use of strong ion-exchange resins enables the CEDI cell to still function electrochemically to transfer protons and hydroxyl ions across the membranes for recombination into pure water, leaving only a concentrated polymeric solution in the cell for recycling to the FO module. Typically, water electrolysis occurs at potentials greater than 1.23 VDC, typically 1.5 VDC, wherein oxygen and hydrogen gases are produced. However, in the proposed invention, water is not electrolyzed, but only ionic splitting and transport of hydrogen cations and hydroxyl anions take place across the relevant membranes under an impressed voltage of 0.8 VDC, after which they recombine into pure water.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for the desalination of fluid having a first salt concentration therein, the system comprising a forward osmosis reactor and an electrodeionization reactor in fluid communication therewith,
where the forward osmosis reactor is configured to take the fluid having the first salt concentration into a first intake port in order to generate a fluid having a higher second salt concentration by directing into a second intake port a fluid having a first solute concentration with a higher osmotic pressure than the fluid having the first salt concentration in order to draw fluid having substantially no salt concentration across a forward osmosis membrane from the fluid having the first salt concentration so as to generate a fluid having a lower second solute concentration, and
where the electrodeionization reactor is configured to take the fluid having the lower second solute concentration and (i) generate substantially desalinated fluid and (ii) regenerate the fluid having substantially the first solute concentration for return to the second intake port of the forward osmosis reactor, the electrodeionization reactor further configured to draw positive and negative ions in the fluid having the lower second solute concentration fluid across cationic and anionic membranes, respectively, by applying a voltage across electrodes sandwiching the cationic and anionic membranes.

2. The system of claim 1 wherein the positive and negative ions in the fluid are those associated with the solute, such that the positive and negative ions can be recombined to substantially regenerate the fluid having the first solute concentration.

3. The system of claim 1 wherein the electrodeionization reactor comprises a continuous electrodeionization reactor configured to introduce cation and anion resin into the fluid having the lower second solute concentration to permit substantially continuous operation of the continuation electrodeionization reactor.

4. The system of claim 1 wherein the solute comprises an ionic salt.

5. The system of claim 4, wherein the cationic and anionic membranes are each a porous polymer gelled electrolyte membrane comprising a substantially saturated solution of the ionic salt.

6. The system of claim 1 wherein the solute comprises a cloud point solute.

7. The system of claim 1 wherein the solute comprises a water-soluble polymer with high osmotic potential.

8. The system of claim 7, wherein the water-soluble polymer comprises non-cloud-point ethoxylates and/or propoxylates.

9. A method for desalinating fluid having a first salt concentration therein, the method comprising
directing into a first intake port of a forward osmosis reactor the fluid having the first salt concentration, and further directing the fluid having a first salt concentration passed a first side of a forward osmosis membrane within the forward osmosis reactor;
directing into a second intake port of the forward osmosis reactor a fluid having a first solute concentration, and further directing the fluid having the first solute concentration passed a second side of the forward osmosis membrane, where the fluid having the first solute concentration has a higher osmotic pressure than the fluid having the first salt concentration, so as to draw across the membrane fluid having substantially no salt concentration to thus generate a fluid having a lower second solute concentration;
directing the fluid having the lower second solute concentration between a cationic membrane and an anionic membrane positioned between positive and negative electrodes; and
applying a voltage across the electrodes so as to draw positive and negative ions across the cationic membrane and anionic membrane, respectively, thereby generating substantially desalinated fluid.

10. The method of claim 9 wherein the positive and negative ions are those associated with the solute.

11. The method of claim 10 further comprising recombining the positive and negative ions of the solute to regenerate fluid having substantially the first solute concentration for return to the second intake port of the forward osmosis reactor.

12. The method of claim 9 further comprising introducing cation and anion resin into the fluid having the lower second solute concentration to permit substantially continuous operation of the continuation electrodeionization reactor.

13. The method of claim 9 wherein the solute comprises an ionic salt.

14. The method of claim 13, wherein the cationic and anionic membranes are each a porous polymer gelled electrolyte membrane comprising a substantially saturated solution of the ionic salt.

15. The system of claim 9 wherein the solute comprises a cloud point solute.

16. The system of claim 9 wherein the solute comprises a water-soluble polymer with high osmotic potential.

17. The system of claim 16, wherein the water-soluble polymer comprises non-cloud-point ethoxylates and/or propoxylates.
